(19) United States
(12) Patent Application Publication
(10) Pub. No.: US 2024/0203154 A1
(43) Pub. Date: Jun. 20, 2024

(54) FINGERPRINT IDENTIFICATION DRIVING CIRCUIT, FINGERPRINT IDENTIFICATION CIRCUIT AND DRIVING METHOD THEREOF

(71) Applicants: Beijing BOE Display Technology Co., Ltd., Beijing (CN); BOE TECHNOLOGY GROUP CO., LTD., Beijing (CN)

(72) Inventors: Peng JIA, Beijing (CN); Fangyuan ZHAO, Beijing (CN); Lei WANG, Beijing (CN); Yangbing LI, Beijing (CN)

(21) Appl. No.: 17/797,801

(22) PCT Filed: Aug. 26, 2021
(86) PCT No.: PCT/CN2021/114790

§ 371 Date: Aug. 5, 2022

(51) Int. Cl. G06V 40/13

(52) U.S. Cl. CPC G06V 40/1318

(57) ABSTRACT

The present disclosure provides a fingerprint identification driving circuit, a fingerprint identification circuit and a driving method thereof. The fingerprint identification driving circuit includes a shift register sub-circuit and an output sub-circuit. The output sub-circuit is configured to transmit a signal input from a first clock signal terminal to a scan signal output terminal of the output sub-circuit for outputting, in response to a signal input from a driving signal output terminal of the shift register sub-circuit; and is further configured to transmit a signal input from a first voltage signal terminal to the scan signal output terminal of the output sub-circuit for outputting, in response to a signal of a first node inside the shift register sub-circuit.

### CROSS REFERENCE TO RELATED APPLICATIONS

This is a National Phase Application filed under 35 U.S.C. 371 as a national stage of PCT/CN2021/114790 filed on Aug. 26, 2021, the content of which is incorporated herein by reference in its entirety.

### TECHNICAL FIELD

The present disclosure relates to the technical field of fingerprint identification, and particularly relates to a fingerprint identification driving circuit, a fingerprint identification circuit, and a driving method for the fingerprint identification circuit.

### BACKGROUND

In the related art, a photosensitive device may be used to converse light of different intensities to a photocurrent of different magnitudes. In this case, due to the difference between a fingerprint valley and a fingerprint ridge, reflected light of different intensities may be generated when light from a light source is irradiated on a finger, such that different photocurrents may be generated and then a fingerprint pattern may be acquired. Specifically, as shown in FIG. 1, each photosensitive unit (i.e., sensor) 01 includes a photosensitive diode and a thin film transistor (TFT). When fingerprint detection is performed, photosensitive diodes are turned on under the control of control thin film transistors by sequentially gating gate lines row by row, and the current differences between the photosensitive diodes are sequentially read, such that the pattern detection on fingerprint valleys and fingerprint ridges can be realized.

However, in the related art, the method for acquiring a fingerprint pattern under strong light has the problems of long fingerprint detection time, slow response, and the like.

### SUMMARY

Some embodiments of the present disclosure provide a fingerprint identification driving circuit, a fingerprint identification circuit, and a driving method for the fingerprint identification circuit.

In a first aspect, the embodiments of the present disclosure provide a fingerprint identification driving circuit including a shift register sub-circuit and an output sub-circuit, wherein the output sub-circuit is configured to transmit a signal input from a first clock signal terminal to a scan signal output terminal of the output sub-circuit for outputting, in response to a signal input from a driving signal output terminal of the shift register sub-circuit: and the output sub-circuit is further configured to transmit a signal input from a first voltage signal terminal to the scan signal output terminal of the output sub-circuit for outputting, in response to a signal of a first node inside the shift register sub-circuit.

Optionally, the shift register sub-circuit includes an input sub-circuit, a reset sub-circuit, and an output control sub-circuit: the input sub-circuit is configured to transmit a signal input from an input signal terminal to a second node in response to a signal input from a second clock signal terminal: the reset sub-circuit is configured to transmit a signal input from a second voltage signal terminal to the first node in response to the signal input from the second clock signal terminal: the output control sub-circuit is configured to transmit a signal input from a third clock signal terminal to the driving signal output terminal in response to a signal of the second node, and is configured to transmit the signal input from the first voltage signal terminal to the driving signal output terminal in response to a signal of the first node: the second node is a connection node between the input sub-circuit and the output control sub-circuit: and the first node is a connection node between the reset sub-circuit and the output control sub-circuit.

Optionally, the input sub-circuit includes: a first transistor having a first electrode connected to the input signal terminal, a second electrode connected to the second node, and a control electrode connected to the second clock signal terminal.

Optionally, the reset sub-circuit includes: a second transistor having a first electrode connected to the second voltage signal terminal, a second electrode connected to the first node, and a control electrode connected to the second clock signal terminal.

Optionally, the output control sub-circuit includes a third transistor, a fourth transistor, a first capacitor, and a second capacitor: a first electrode of the third transistor is connected to the third clock signal terminal, a second electrode of the third transistor is connected to the driving signal output terminal, and a control electrode of the third transistor is connected to the second node: one terminal of the first capacitor is electrically connected to the control electrode of the third transistor, and the other terminal of the first capacitor is connected to the second electrode of the third transistor: a first electrode of the fourth transistor is connected to the driving signal output terminal, a second electrode of the fourth transistor is connected to the first voltage signal terminal, and a control electrode of the fourth transistor is connected to the first node: and one terminal of the second capacitor is electrically connected to the control electrode of the fourth transistor, and the other terminal of the second capacitor is connected to the second electrode of the fourth transistor.

Optionally, the output sub-circuit includes a fifth transistor and a sixth transistor: a first electrode of the fifth transistor is connected to the first clock signal terminal, a second electrode of the fifth transistor is connected to the scan signal output terminal, and a control electrode of the fifth transistor is connected to the driving signal output terminal: and a first electrode of the sixth transistor is connected to the first voltage signal terminal, a second electrode of the sixth transistor is connected to the scan signal output terminal, and a control electrode of the sixth transistor is connected to the first node.

Optionally, the fingerprinting identification driving circuit further includes a first control sub-circuit configured to transmit a signal of a second clock signal terminal to the first node in response to a signal of a second node.

Optionally, the first control sub-circuit includes: a seventh transistor having a first electrode connected to the first node, a second electrode connected to the second clock signal terminal, and a control electrode connected to the second node.

Optionally, the fingerprinting identification driving circuit further includes a second control sub-circuit configured to transmit a signal output from the first voltage signal terminal to a second node in response to a signal transmitted from a third clock signal terminal and a signal transmitted from the first node.

Optionally, the second control sub-circuit includes an eighth transistor and a ninth transistor: a first electrode of the eighth transistor is connected to a second electrode of the ninth transistor, and a second electrode of the eighth transistor is connected to the second node: a control electrode of the eighth transistor is connected to the third clock signal terminal: a first electrode of the ninth transistor is connected to the first voltage signal terminal, and a control electrode of the ninth transistor is connected to the first node.

In a second aspect, the embodiments of the present disclosure provide a fingerprint identification circuit including: the above fingerprint identification driving circuits, m driving signal lines and n reading signal lines crossing over the m driving signal lines, and photosensitive units arranged in an array of m×n, wherein the photosensitive units in a same row are connected to a same driving signal line, and the photosensitive units in a same column are connected to a same reading signal line: the driving signal output terminal of an N-th stage fingerprint identification driving circuit is connected to an input sub-circuit of an (N+1)-th stage fingerprint identification driving circuit: and the scan signal output terminal of the N-th stage fingerprint identification driving circuit is connected to an m-th driving signal line, where N=m, and N, n and m are positive integers.

In a third aspect, the embodiments of the present disclosure provide a driving method for driving the above fingerprint recognition circuit, including: outputting, from the driving signal output terminal of an N-th stage shift register sub-circuit, a turn-on level signal to control starting of the output sub-circuit, wherein a signal of the first clock signal terminal is transmitted to the m-th driving signal line connected to the scan signal output terminal through the started output sub-circuit, such that a reset operation and a reading operation are performed on the photosensitive units based on a signal input from the m-th driving signal line: after completion of the reset operation and the reading operation on the photosensitive units connected to the m-th driving signal line, outputting, from the driving signal output terminal of the N-th stage shift register sub-circuit, a turn-on level signal to the input sub-circuit of an (N+1)-th stage shift register sub-circuit for starting the (N+1)-th stage fingerprint identification driving circuit: and then, outputting, at the driving signal output terminal of the (N+1)-th stage shift register sub-circuit, a turn-on level signal to control the starting of the output sub-circuit in a same stage, wherein the signal of the first clock signal terminal is output to an (m+1)-th driving signal line connected to the scan signal output terminal through the started output sub-circuit, such that a reset operation and a reading operation are performed on the photosensitive units based on a signal input from the (m+1)-th driving signal line.

In a fourth third aspect, the embodiments of the present disclosure provide a driving method for driving the above fingerprint recognition circuit, including: outputting, from the driving signal output terminal of an N-th stage shift register sub-circuit, a turn-on level signal to control starting of the output sub-circuit, wherein a signal of the first clock signal terminal is transmitted to the m-th driving signal line connected to the scan signal output terminal through the started output sub-circuit, such that a reset operation and a reading operation are performed on the photosensitive units based on a signal input from the m-th driving signal line: after completion of the reset operation on the photosensitive units connected to the m-th driving signal line, outputting, from the driving signal output terminal of the N-th stage shift register sub-circuit, a turn-on level signal to the input sub-circuit of an (N+1)-th stage shift register sub-circuit for starting the (N+1)-th stage fingerprint identification driving circuit: and then, outputting, from the driving signal output terminal of the (N+1)-th stage shift register sub-circuit, a turn-on level signal to control the starting of the output sub-circuit in a same stage, wherein the signal of the first clock signal terminal is output to an (m+1)-th driving signal line connected to the scan signal output terminal through the started output sub-circuit, such that a reset operation is performed on the photosensitive units based on a signal input from the (m+1)-th driving signal line: after completion of the reset operation on all the rows of photosensitive units, outputting, from the driving signal output terminal of the N-th stage shift register sub-circuit, a turn-on level signal to control the starting of the output sub-circuit, wherein the signal of the first clock signal terminal is transmitted to the m-th driving signal line connected to the scan signal output terminal through the started output sub-circuit, such that a reading operation is performed on the photosensitive units based on a signal input from the (m)-th driving signal line:

and after completion of the reading operation on the photosensitive units connected to the m-th driving signal line, outputting, from the driving signal output terminal of the N-th stage shift register sub-circuit, a turn-on level signal to the input sub-circuit of the (N+1)-th stage shift register sub-circuit for starting the (N+1)-th stage fingerprint identification driving circuit: and then, outputting, from the driving signal output terminal of the (N+1)-th stage shift register sub-circuit, a turn-on level signal to control the starting of the output sub-circuit in a same stage, wherein the signal of the first clock signal terminal is output to the (m+1)-th driving signal line connected to the scan signal output terminal through the started output sub-circuit, such that a reading operation is performed on the photosensitive units based on a signal input from the (m+1)-th driving signal line until completion of the reading operation on all the rows of photosensitive units.

### BRIEF DESCRIPTION OF DRAWINGS

FIG. 1 is a schematic diagram of a structure of an exemplary fingerprint identification circuit:

FIG. 2 is a schematic timing diagram of the fingerprint identification circuit shown in FIG. 1 when performing driving and acquiring a fingerprint pattern:

FIG. 3 is a schematic diagram of a structure of a fingerprint identification driving circuit according to an embodiment of the present disclosure:

FIG. 4 is a schematic diagram of a structure of another fingerprint identification driving circuit according to an embodiment of the present disclosure:

FIG. 5 is a timing diagram for driving the fingerprint identification driving circuit shown in FIG. 4:

FIG. 6 is an equivalent circuit diagram of the fingerprint identification driving circuit shown in FIG. 4 at a first stage:

FIG. 7 is an equivalent circuit diagram of the fingerprint identification driving circuit shown in FIG. 4 at a second stage:

FIG. 8 is an equivalent circuit diagram of the fingerprint identification driving circuit shown in FIG. 4 at a third stage:

FIG. 9 is an equivalent circuit diagram of the fingerprint identification driving circuit shown FIG. 4 at a fourth stage:

FIG. 10 is a schematic diagram of a structure of a fingerprint identification circuit according to an embodiment of the present disclosure:

FIG. 11 is a flowchart of a driving method for the fingerprint identification circuit shown in FIG. 10 according to an embodiment of the present disclosure:

FIG. 12 is a flowchart of a determination method of an integration time according to an embodiment of the present disclosure:

FIG. 13 is a flowchart of another determination method of an integration time according to an embodiment of the present disclosure:

FIG. 14 is a flowchart of another driving method for the fingerprint identification circuit shown in FIG. 10 according to an embodiment of the present disclosure: and

FIG. 15 is another timing diagram for driving the fingerprint identification driving circuit shown in FIG. 4.

### DETAIL DESCRIPTION OF EMBODIMENTS

In order to make one of ordinary skill in the art better understand the technical solutions of the present disclosure, the following detailed description is given with reference to the drawings and the specific embodiments.

Unless defined otherwise, technical or scientific terms used herein shall have the ordinary meaning as understood by one of ordinary skill in the art to which the present disclosure belongs. The words “first,” “second,” and the like in present disclosure are not intended to indicate any order, quantity, or importance, but rather are used to distinguish one element from another. Similarly, the word “a,” “an,” “the,” or the like does not denote a limitation of quantity, but rather denotes the presence of at least one element. The word “comprising,” “including,” or the like, means that the element or item preceding the word contains the element or item listed after the word and its equivalent, but does not exclude other elements or items. The word “connected,” “coupled,” or the like is not restricted to physical or mechanical connections, but may include electrical connections, whether direct or indirect connections. The words “upper,” “lower,” “left,” “right,” and the like are used only to indicate relative positional relationships, and when the absolute position of the object being described is changed, the relative positional relationships may also be changed accordingly.

It should be noted that, the transistors used in the embodiments of the present disclosure may be thin film transistors or field effect transistors or other devices with the same characteristics, and since the source electrode and the drain electrode of each transistor used are symmetrical, the source electrode and the drain electrode are not different from each other. In the embodiments of the present disclosure, to distinguish the source electrode and the drain electrode of each transistor from each other, one of the source electrode and the drain electrode is referred to as a first electrode, the other of the source electrode and the drain electrode is referred to as a second electrode, and the gate electrode thereof is referred to as a control electrode. In addition, the transistors may be classified as N-type transistors and P-type transistors based on the characteristics of the transistors, and in the following embodiments, a P-type transistor is taken as an example for description. When a P-type transistor is used, the first electrode is a source electrode of the P-type transistor, and the second electrode is a drain electrode of the P-type transistor. When a low level is input to the gate electrode of the P-type transistor, the source electrode and the drain electrode of the P-type transistor are electrically connected with each other, and the N-type transistor is turned-on by a high level at the gate electrode thereof opposite to the low level at the gate electrode of the P-type transistor. It is conceivable that the implementation of the present inventive concept by using N-type transistors can be easily carried out by one of ordinary skill in the art without creative work, and therefore also falls within the protection scope of the embodiments of the present disclosure.

In the embodiment of the present disclosure, since each transistor used is a P-type transistor, the turn-on level signal in the embodiment of the present disclosure refers to a low level signal, and the turn-off level signal refers to a high level signal: and correspondingly the turn-on level terminal is a low level signal terminal, and the turn-off level terminal is a high level signal terminal. The first power supply voltage supplied to the first power supply voltage terminal is higher than the second power supply voltage supplied to the second power supply voltage terminal. In the embodiments of the present disclosure, the case where the first power supply voltage is a high power supply voltage and the second power supply voltage is a low power supply voltage is taken as an example.

FIG. 1 is a schematic diagram of a structure of an exemplary fingerprint identification circuit. As shown in FIG. 1, each photosensitive unit (i.e., sensor) 01 includes one photosensitive diode 011 and one thin film transistor (TFT) 012. When fingerprint detection is performed, photosensitive diodes 011 are turned on under control of thin film transistors 012 through sequentially gating driving signal lines G row by row by shift registers 02, and pattern detection on fingerprint valleys and fingerprint ridges can be realized by sequentially reading current differences between photosensitive diodes 011 through reading signal lines R.

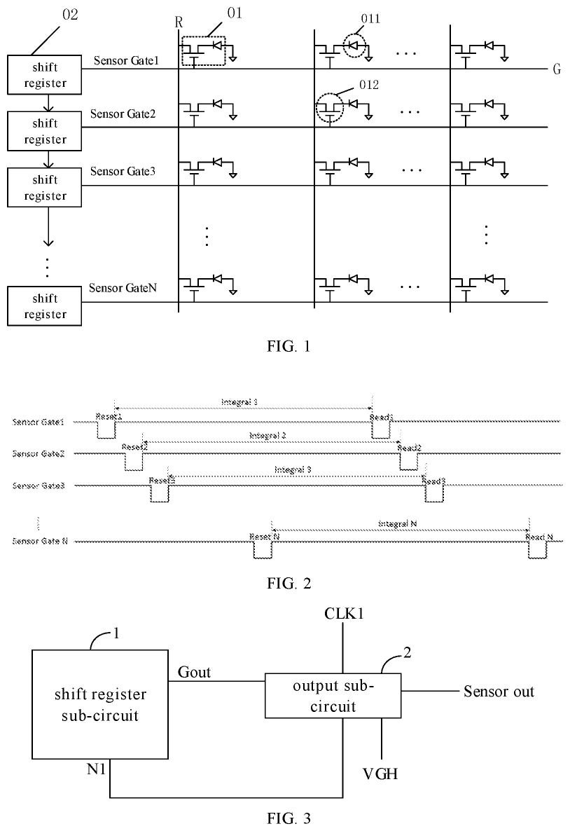

FIG. 2 is a schematic timing diagram of the fingerprint identification circuit shown in FIG. 1 when performing driving and acquiring a fingerprint pattern. As shown in FIGS. 1 and 2, when performing the fingerprint identification, in the scanning process of each photosensitive unit 01 there are three stages, which are a reset (i.e., “Reset” as shown) stage, an integration (i.e., “Integral” as shown) stage, and a read (i.e., “Read” as shown) stage. Each of the shift registers 02 corresponds to a row of photosensitive units (i.e., sensors) 01 in the fingerprint identification circuit. In the scanning process of the fingerprint identification driving circuit, first, respective rows of sensors are reset sequentially by the output of the shift registers 02, respectively, then the respective rows of sensors start to enter the integration stage, and finally the shift registers perform driving again sequentially row by row and the respective rows of sensors are read based on the output of the shift registers 02, respectively.

Continuing to refer to FIG. 1 and FIG. 2, driving of P-type thin film transistors is taken as an example in the present disclosure. The thin film transistors 012 are turned on by a low level output from each shift register 02, and are turned off by a high level output from each shift register 02. For a certain row of photosensitive units 01, the three stages of the reset stage, the integration stage and the read stage are sequentially performed. A same integration time for respective rows of photosensitive units 01 in an entire photosensitive unit array is needed to ensure the uniformity of an image. A shortest integration time is limited by the number N of the rows of the photosensitive unit array, that is, the shortest integration time is the time duration for completing reset of all the rows of the photosensitive unit array. In some specific application scenarios or conditions, such as a strong light environment, a long integration time of the photosensitive units 01 may cause the photosensitive diodes 011 to be saturated, so that the fingerprint identification cannot be achieved. Meanwhile, the long integration time of the photosensitive units 01 may further cause a long time duration for the fingerprint identification, thereby reducing the speed of fingerprint identification.

In order to solve at least one of the above technical problems, a fingerprint identification driving circuit, a fingerprint identification circuit, and a driving method for a fingerprint identification circuit are provided in the embodiments of the present disclosure. The fingerprint identification driving circuit, the fingerprint identification circuit, and the driving method for the fingerprint identification circuit in the embodiments of the present disclosure will be described in further detail below with reference to the drawings and specific embodiments.

In a first aspect, FIG. 3 is a schematic diagram of a structure of a fingerprint identification driving circuit according to an embodiment of the present disclosure. As shown in FIG. 3, the fingerprint identification driving circuit in the embodiments of the present disclosure includes a shift register sub-circuit 1 and an output sub-circuit 2.

Specifically, the output sub-circuit 2 is configured to transmit a signal input from a first clock signal terminal CLK1 to a scan signal output terminal Sensor out of the output sub-circuit 2 for outputting, in response to a signal input from a driving signal output terminal Gout of the shift register sub-circuit 1. The output sub-circuit 2 is further configured to transmit a signal input from a first voltage signal terminal VGH to the scan signal output terminal Sensor out of the output sub-circuit 2 for outputting, in response to a signal of a first node N1 inside the shift register sub-circuit 1.

In the present embodiment, a scan line switching signal is provided at the driving signal output terminal Gout of the shift register sub-circuit 1, and a driving signal for one row of photosensitive units 01 is provided by the output sub-circuit 2, so that the timing sequence of respective driving signals may be adjusted based on different application scenarios. That is, an adjustable integration time can be realized, such that the photosensitive units 01 are not saturated under strong light, and the speed of fingerprint identification is increased.

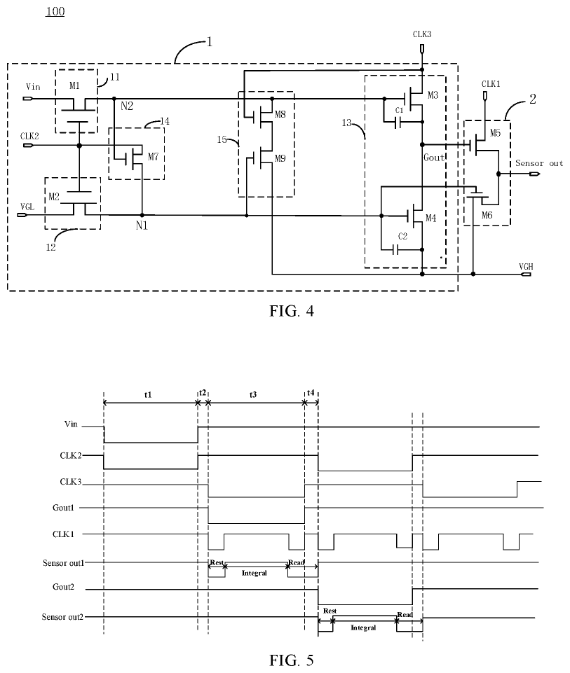

In some embodiments, FIG. 4 is a schematic diagram of a structure of another fingerprint identification driving circuit according to an embodiment of the present disclosure. As shown in FIG. 4, the fingerprint identification driving circuit 100 includes a shift register sub-circuit 1 and an output sub-circuit 2. The shift register sub-circuit 1 includes an input sub-circuit 11, a reset sub-circuit 12, and an output control sub-circuit 13.

The input sub-circuit 11 is configured to transmit a signal input from an input signal terminal Vin to a second node N2 in response to a signal input from a second clock signal terminal CLK2. The reset sub-circuit 12 is configured to transmit a signal input from a second voltage signal terminal VGL to the first node N1 in response to the signal input from the second clock signal terminal CLK2. The output control sub-circuit 13 is configured to transmit a signal input from a third clock signal terminal CLK3 to the driving signal output terminal Gout in response to a signal of the second node N2, and the output control sub-circuit 13 is configured to transmit a signal input from the first voltage signal terminal VGH to the driving signal output terminal Gout in response to the signal of the first node N1. The second node N2 is a connection node between the input sub-circuit 11 and the output control sub-circuit 13, and the first node N1 is a connection node between the reset sub-circuit 12 and the output control sub-circuit 13.

In the present embodiment, a scan line switching signal is provided at the driving signal output terminal Gout of the shift register sub-circuit 1, and a driving signal for one row of photosensitive units 01 is provided by the output sub-circuit 2, so that the timing sequence of respective driving signals can be adjusted according to different application scenarios, that is, the adjustable integration time can be realized. As such, the photosensitive units 01 are not saturated under strong light, and the speed of fingerprint identification is increased.

In some embodiments, as shown in FIG. 4, the input sub-circuit 11 includes a first transistor M1 having a first electrode connected to the input signal terminal Vin, a second electrode connected to the second node N2, and a control electrode connected to the second clock signal terminal CLK2.

In some embodiments, as shown in FIG. 4, the reset sub-circuit 12 includes a second transistor M2 having a first electrode connected to the second voltage signal terminal VGL, a second electrode connected to the first node N1, and a control electrode connected to the second clock signal terminal CLK2.

In some embodiments, as shown in FIG. 4, the output control sub-circuit 13 includes a third transistor M3, a fourth transistor M4, a first capacitor C1, and a second capacitor C2. The third transistor M3 has a first electrode connected to the third clock signal terminal CLK3, a second electrode connected to the driving signal output terminal Gout, and a control electrode connected to the second node N2. One terminal of the first capacitor C1 is electrically connected to the control electrode of the third transistor M3, and the other terminal of the first capacitor C1 is connected to the second electrode of the third transistor M3. The fourth transistor M4 has a first electrode connected to the driving signal output terminal Gout, a second electrode connected to the first voltage signal terminal VGH, and a control electrode connected to the first node N1. One terminal of the second capacitor C2 is electrically connected to the control electrode of the fourth transistor M4, and the other terminal of the second capacitor C2 is connected to the second electrode of the fourth transistor M4.

In some embodiments, as shown in FIG. 4, the output sub-circuit 2 includes a fifth transistor M5 and a sixth transistor M6. The fifth transistor M5 has a first electrode connected to the first clock signal terminal CLK1, a second electrode connected to the scan signal output terminal Sensor out, and a control electrode connected to the driving signal output terminal Gout. The sixth transistor M6 has a first electrode connected to the first voltage signal terminal VGH, a second electrode connected to the scan signal output terminal Sensor out, and a control electrode connected to the first node N1.

In some embodiments, as shown in FIG. 4, the fingerprint recognition driving circuit further includes a first control sub-circuit 14 configured to transmit a signal of the second clock signal terminal CLK2 to the first node N1 in response to a signal of the second node N2.

In some embodiments, as shown in FIG. 4, the first control sub-circuit 14 includes a seventh transistor M7 having a first electrode connected to the first node N1, a second electrode connected to the second clock signal terminal CLK2, and a control electrode connected to the second node N2.

In some embodiments, as shown in FIG. 4, the fingerprint recognition driving circuit further includes a second control sub-circuit 15 configured to transmit a signal output from the first voltage signal terminal VGH to the second node N2 in response to the signals transmitted from the third clock signal terminal CLK3 and the first node N1.

In some embodiments, as shown in FIG. 4, the second control sub-circuit 15 includes an eighth transistor M8 and a ninth transistor M9. The eighth transistor M8 has a first electrode connected to a second electrode of the ninth transistor M9, a second electrode connected to the second node N2, and a control electrode connected to the third clock signal terminal CLK3. A first electrode of the ninth transistor M9 is connected to the first voltage signal terminal VGH, and a control electrode of the ninth transistor M9 is connected to the first node N1.

In the present embodiment, the stability of the output signal of the fingerprint identification driving circuit can be enhanced by providing the first control sub-circuit 14 and the second control sub-circuit 15.

In order to make the structure of the fingerprint identification driving circuit in the embodiment of the present invention clearer, the structure and the operation process of the embodiment of the present invention are described in connection with the following specific examples.

As shown in FIG. 4, the fingerprint identification driving circuit includes the shift register sub-circuit 1 and the output sub-circuit 2. The shift register sub-circuit 1 includes the input sub-circuit 11, the reset sub-circuit 12, the output control sub-circuit 13, the first control sub-circuit 14 and the second control sub-circuit 15. The input sub-circuit 11 includes the first transistor M1: the reset sub-circuit includes the second transistor M2: the output control sub-circuit 13 includes the third transistor M3, the fourth transistor M4, the first capacitor C1, and the second capacitor C2: the output sub-circuit 2 includes the fifth transistor M5 and the sixth transistor M6: the first control sub-circuit 14 includes the seventh transistor M7: and the second control sub-circuit 15 includes the eighth transistor M8 and the ninth transistor M9.

Specifically, the first electrode of the first transistor M1 is connected to the input signal terminal Vin, the second electrode of the first transistor M1 is connected to the second node N2, and the control electrode of the first transistor M1 is connected to the second clock signal terminal CLK2. The first electrode of the second transistor M2 is connected to the second voltage signal terminal VGL, the second electrode of the second transistor M2 is connected to the first node N1, and the control electrode of the second transistor M2 is connected to the second clock signal terminal CLK2. The first electrode of the third transistor M3 is connected to the third clock signal terminal CLK3, the second electrode of the third transistor M3 is connected to the driving signal output terminal Gout, and the control electrode of the third transistor M3 is connected to the second node N2. One terminal of the first capacitor C1 is electrically connected to the control electrode of the third transistor M3, and the other terminal of the first capacitor C1 is connected to the second electrode of the third transistor M3. The first electrode of the fourth transistor M4 is connected to the driving signal output terminal Gout, the second electrode of the fourth transistor M4 is connected to the first voltage signal terminal VGH, and the control electrode of the fourth transistor M4 is connected to the first node N1. One terminal of the second capacitor C2 is electrically connected to the control electrode of the fourth transistor M4, and the other terminal of the second capacitor C2 is connected to the second electrode of the fourth transistor M4. The first electrode of the fifth transistor M5 is connected to the first clock signal terminal CLK1, the second electrode of the fifth transistor M5 is connected to the scan signal output terminal Sensor out, and the control electrode of the fifth transistor M5 is connected to the driving signal output terminal Gout. The first electrode of the sixth transistor M6 is connected to the first voltage signal terminal VGH, the second electrode of the sixth transistor M6 is connected to the scan signal output terminal Sensor out, and the control electrode of the sixth transistor M6 is connected to the first node N1. The first electrode of the seventh transistor M7 is connected to the first node N1, the second electrode of the seventh transistor M7 is connected to the second clock signal terminal CLK2, and the control electrode of the seventh transistor M7 is connected to the second node N2. The first electrode of the eighth transistor M8 is connected to the second electrode of the ninth transistor M9, and the second electrode of the eighth transistor M8 is connected to the second node N2. The control electrode of the eighth transistor M8 is connected to the third clock signal terminal CLK3. The first electrode of the ninth transistor M9 is connected to the first voltage signal terminal VGH, and the control electrode of the ninth transistor M9 is connected to the first node N1.

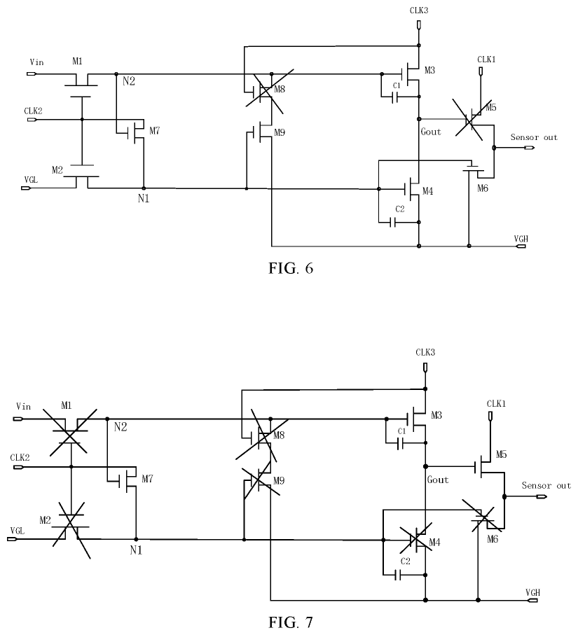

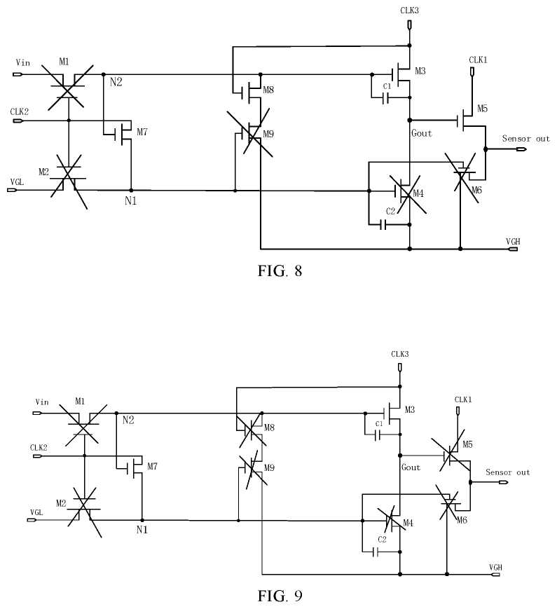

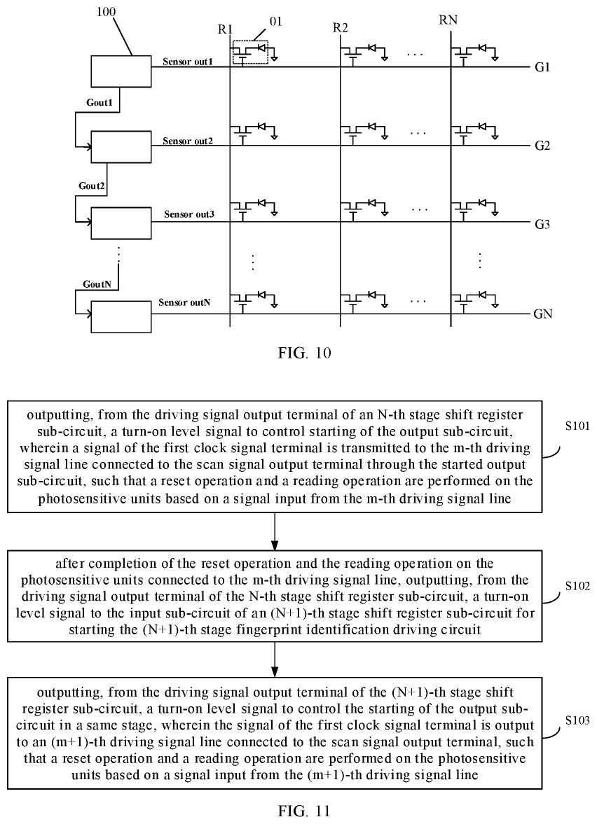

FIG. 5 is a timing diagram for driving the fingerprint identification driving circuit shown in FIG. 4. FIG. 6 is an equivalent circuit diagram of the fingerprint identification driving circuit shown in FIG. 4 at a first stage. FIG. 7 is an equivalent circuit diagram of the fingerprint identification driving circuit shown in FIG. 4 at a second stage. FIG. 8 is an equivalent circuit diagram of the fingerprint identification driving circuit shown in FIG. 4 at a third stage. FIG. 9 is an equivalent circuit diagram of the fingerprint identification driving circuit shown FIG. 4 at a fourth stage. A fingerprint recognition driving circuit according to an embodiment of the present disclosure can be more clearly understood by describing below how the fingerprint recognition driving circuit operates with reference to FIGS. 4 to 9.

In a first stage (t1), a low level signal is input from the input signal terminal Vin, a low level signal is input from the second clock signal terminal CLK2, a high level signal is input from the third clock signal terminal CLK3, and a high level signal is input from the first clock signal terminal CLK1. As shown in FIG. 6, when the low level signal is input from the second clock signal terminal CLK2, the first transistor M1 and the second transistor M2 are turned on. The low level signal input from the input signal terminal Vin is transmitted to the second node N2, and the low level signal input from the second voltage signal terminal VGL is transmitted to the first node N1. Since the second node N2 is inputted with the low level signal, the seventh transistor M7 is turned on, and the voltage of the second node N2 is transmitted to the first node N1. The low level signal of the second node N2 is transmitted to the control electrode of the third transistor M3, and the third transistor M3 is controlled to be turned on: and at this time, the high level signal inputted from the third clock signal terminal CLK3 is transmitted to the driving signal output terminal Gout. The high level signal is output from the driving signal output terminal Gout to control the fifth transistor to be turned off. The first capacitor C1 and the second capacitor C2 are charged at this stage. On the other hand, since the second transistor M2 is turned on, the low level signal input from the second voltage signal terminal VGL is transmitted to the first node N1. The fourth transistor M4 and the sixth transistor M6 are controlled to be turned on by the voltage of the first node N1, and the high level signal of the first voltage signal terminal VGH is transmitted to the scan signal output terminal Sensor out through the sixth transistor M6. In this case, a high level is output from the scan signal output terminal Sensor out.

In the second stage (t2), a high level signal is input from the input signal terminal Vin, a high level signal is input from the second clock signal terminal CLK2, a high level signal is input from the third clock signal terminal CLK3, and a high level signal is input from the first clock signal terminal CLK1. As shown in FIG. 7, since the high level signal is input from the second clock signal terminal CLK2, the first transistor M1 and the second transistor M2 are turned off. The control electrode of the seventh transistor M7 is kept at a low level, and the seventh transistor M7 is still turned on. At this stage, since the seventh transistor M7 is still turned on, the level of the first node N1 is pulled high, and thus the ninth transistor M9, the fourth transistor M4 and the sixth transistor M6 are turned off. In this case, a high level is output from the scan signal output terminal Sensor out.

In a third stage (t3), a high level signal is input from the input signal terminal Vin, a high level signal is input from the second clock signal terminal CLK2, a low level signal is input from the third clock signal terminal CLK3, and a fingerprint scan signal is input from the first clock signal terminal CLK1. As shown in FIG. 8, the first transistor M1, the second transistor M2, the ninth transistor M9, the fourth transistor M4 and the sixth transistor M6 are turned off: and the third transistor M3, the fifth transistor M5 and the seventh transistor M7 are turned on. In this case, the low level signal inputted from the third clock signal terminal CLK3 passes through the turned-on third transistor M3 to reach the signal output terminal Gout, thereby controlling the fifth transistor M5 to be turned on. Then, the fingerprint scan signal inputted from the first clock signal terminal CLK1 passes through the fifth transistor M5 to reach the scan signal output terminal Sensor out, and at this time, the fingerprint scan signal is output from the scan signal output terminal Sensor out.

In a fourth stage (t4), a high level signal is input from the input signal terminal Vin, a high level signal is input from the second clock signal terminal CLK2, a high level signal is input from the third clock signal terminal CLK3, and a high level signal is input from the first clock signal terminal CLK1. As shown in FIG. 9, the first transistor M1, the second transistor M2, the fourth transistor M4, the fifth transistor M5, the sixth transistor M6, the eighth transistor M8, and the ninth transistor M9 are turned off: and the third transistor M3 and the seventh transistor M7 are turned on. At this time, a high level signal is output from the scan signal output terminal Sensor out.

In the present embodiment, the signal output from the scan signal output terminal Sensor out is controlled by the signal input from the third clock signal terminal CLK3, and thus the timing sequence of the fingerprint scan signal input from the third clock signal terminal CLK3 can be adjusted according to different application scenarios, that is, the integration (or integral) time can be adjusted, so that each photoreceptive unit is not saturated under strong light, and the speed of fingerprint identification is increased.

It should be noted that, in the present embodiment, the shift register sub-circuit 1 is described by taking the circuit of 7T2C (i.e., 7 transistors and 2 capacitors) as an example, but the present disclosure is not limited thereto. It is to be understood that, other types of shift register sub-circuits 1 may be selected by one of ordinary skill in the art, for example, each shift register sub-circuit 1 may alternatively have a structure of 9T2C, and therefore, embodiments using different types of shift register sub-circuits are within the scope of the present disclosure.

In a second aspect, FIG. 10 is a schematic diagram of a structure of a fingerprint identification circuit according to an embodiment of the present disclosure. As shown in FIG. 10, the fingerprint identification circuit includes a fingerprint identification driving circuit 100, m driving signal lines (G1˜GN) and n reading signal lines (R1˜RN) intersecting with (or crossing over) the m driving signal lines (G1˜GN), and m×n photosensitive units 01 arranged in an array (or a matrix) of m×n. The photosensitive units 01 arranged in a same row are connected to a same driving signal line, and the photosensitive units 01 arranged in a same column are connected to a same reading signal line. Each driving signal extends along a first direction, each reading signal line extends along a second direction, and the first direction is perpendicular to the second direction.

With continued reference to FIGS. 10 and 4, the driving signal output terminal Gout of an N-th stage fingerprint identification driving circuit (i.e., a fingerprint identification driving circuit in an N-th stage) is connected to the input sub-circuit 11 of an (N+1)-th stage fingerprint identification driving circuit (i.e., a fingerprint identification driving circuit in an (N+1)-th stage). The scan signal output terminal Sensor out of the N-th stage fingerprint identification driving circuit is connected to m driving signal lines, where N=m, and N, n and m are positive integers. For example, the driving signal output terminal Gout of a first stage fingerprint identification driving circuit is connected to the input sub-circuit 11 of a second stage fingerprint identification driving circuit, and the scan signal output terminal Sensor out of the first stage fingerprint identification driving circuit is connected to a first driving signal line G1: the driving signal output terminal Gout of the second stage fingerprint identification driving circuit is connected to the input sub-circuit 11 of a third stage fingerprint identification driving circuit, the scan signal output terminal Sensor out of the second stage fingerprint identification driving circuit is connected to a second driving signal line G2, and so on: and the scan signal output terminal Sensor out of the N-th stage fingerprint identification driving circuit is connected to the m-th driving signal line GN.

In the present embodiment, referring to FIG. 10, the scan line switching control signal is output from the driving signal output terminal Gout to control the specific number of rows for scanning. When all the photosensitive units in any row are scanned, a fingerprint scan signal is output from the scan signal output terminal Sensor out. Since the signal output from the scan signal output terminal Sensor out is controlled by the signal input from the third clock signal terminal CLK3, the timing sequence of the fingerprint scan signal input from the third clock signal terminal CLK3 can be adjusted based on different application scenarios, i.e., the integration (or integral) time can be adjusted, so that each photosensitive unit is not saturated under strong light, and the speed of fingerprint identification is increased.

In a third aspect, FIG. 11 is a flowchart of a driving method for the fingerprint identification circuit shown in FIG. 10 according to an embodiment of the present disclosure, and as shown in FIG. 11, the driving method for driving the fingerprint identification circuit includes the following steps S101 to S103.

At step S101, a turn-on level signal is output from the driving signal output terminal of the N-th stage shift register sub-circuit to control the starting (i.e., turning on or turning-on) of the output sub-circuit, and the signal of the first clock signal terminal is transmitted to the m-th driving signal line connected to the scan signal output terminal through the started (i.e., turned-on) output sub-circuit, so that a reset operation and a reading operation are performed on the photosensitive units based on a signal input from the m-th driving signal line.

At step S102, after the completion of the reset operation and the reading operation on the photosensitive units connected to the m-th driving signal line, a turn-on level signal for starting the (N+1)-th stage fingerprint identification driving circuit is output from the driving signal output terminal of the N-th stage shift register sub-circuit to the input sub-circuit of the (N+1)-th stage shift register sub-circuit.

At step S103, a turn-on level signal for starting the output sub-circuit in the same stage is output from the driving signal output terminal of the (N+1)-th stage shift register sub-circuit, and the signal of the first clock signal terminal is output to the (m+1)-th driving signal line connected to the scan signal output terminal, so that a reset operation and a reading operation are performed on the photosensitive units based on a signal input from the (m+1)-th driving signal line.

Illustratively, as shown in FIGS. 4, 5 and 10, for example, firstly, a turn-on level signal for controlling the starting of the output sub-circuit 2 is output from the driving signal output terminal Gout1 of a first stage shift register sub-circuit 100, and the signal of the first clock signal terminal CLK1 is transmitted to the first driving signal line G1 connected to the scan signal output terminal Sensor out1 through the output sub-circuit 2, so that a reset (Reset) operation and a reading (Read) operation are performed on the photoreceptive units 01 based on a signal input from the first driving signal line G1.

Then, after the completion of the reset (Reset) operation and the reading (Read) operation on the photosensitive units 01 connected to the first driving signal line G1, a turn-on level signal is output from the driving signal output terminal Gout1 of the first stage shift register sub-circuit to the input sub-circuit 11 of the second stage shift register sub-circuit, to start (i.e., to turn on) the second stage fingerprint identification driving circuit. Then, a turn-on level signal for controlling the starting of the output sub-circuit 2 in the same stage is output from the driving signal output terminal Gout2 of the second stage shift register sub-circuit, and then the signal of the first clock signal terminal CLK1 is output to the second driving signal line G2 connected to the scan signal output terminal Sensor out2, so that a reset (Reset) operation and a reading (Read) operation are performed on the photoreceptive units 01 based on the signal input from the second driving signal line G2.

The time duration of the integration (i.e., Integral) stage can be determined by any one of the following two methods.

In the first method, during the scanning operation of the sensors, N integration time durations, such as T1, T2, T3, . . . , and TN, have been preset inside the system, and represent different integration times from small to large. Each of the integration times is in a one-to-one correspondence with an ambient light intensity. There are N grades for the ambient light from the minimum Dark state to the maximum 10 W luxes (i.e., the maximum intensity of the ambient light is assumed to be 10 W 1×), and then the N grades of the integration times are T1 to TN.

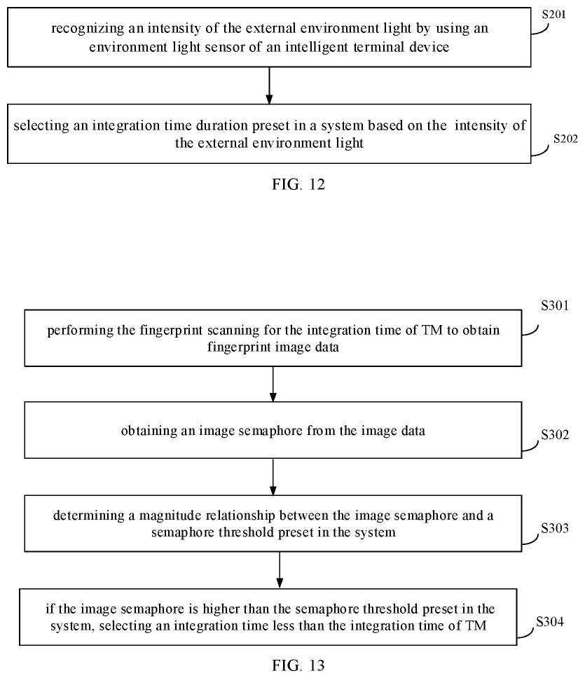

FIG. 12 is a flowchart of a determination method of an integration time according to an embodiment of the present disclosure. At step S201, the intensity of the external environment light is recognized by using an environment light sensor of an intelligent terminal device. At step S202, a preset integration time duration of the system is selected based on the intensity of the external environment light. An integration time duration corresponds to a time sequence of the third clock signal.

A second method is shown in FIG. 13 which is a flowchart of another determination method of an integration time according to an embodiment of the present disclosure. A certain integration time TM is preset in the system, the TM is a grade (or value) between the preset integration time durations T1 and TN of the system, and a certain semaphore threshold is preset. In the process of fingerprint scanning, firstly, the fingerprint scanning is performed for the integration time of TM, so as to obtain fingerprint image data (S301): an image semaphore can be obtained from the image data (S302): a magnitude relationship between the image semaphore and the semaphore threshold preset by the system is determined (S303): and if the image semaphore is higher than the semaphore threshold preset by the system, the integration time lower than the integration time of TM is selected (S304), and then the time sequence of the third clock signal is determined based on the selected integration time.

In the present embodiment, it is assumed that the time for completing the reset scanning of N rows of sensors is TO, which is a value between the preset integration time durations T1 and TN of the system. In the fingerprint scanning process, after a required integration time duration is determined as T, which is a value between the preset integration time durations T1 and TN of the system. If the determined integration time T is less than the time TO for completing the reset scanning of the N rows of sensors, in the fingerprint identification circuit according to the embodiment of the present disclosure, the operations of the reset scanning, the sensor integration, and the sensor reading scanning, on the first row of sensors, on the second row of sensors, and so on, are sequentially implemented until completing the fingerprint scanning of the N rows of sensors.

In the present embodiment, since the signal output from the scan signal output terminal Sensor out is controlled by the signal output from the third clock signal terminal CLK3, the timing sequence of the fingerprint identification signal output from the third clock signal terminal CLK3 can be adjusted based on different application scenarios, i.e., the integration time can be adjusted, so that each sensor is not saturated under strong light, and the speed of fingerprint identification is increased.

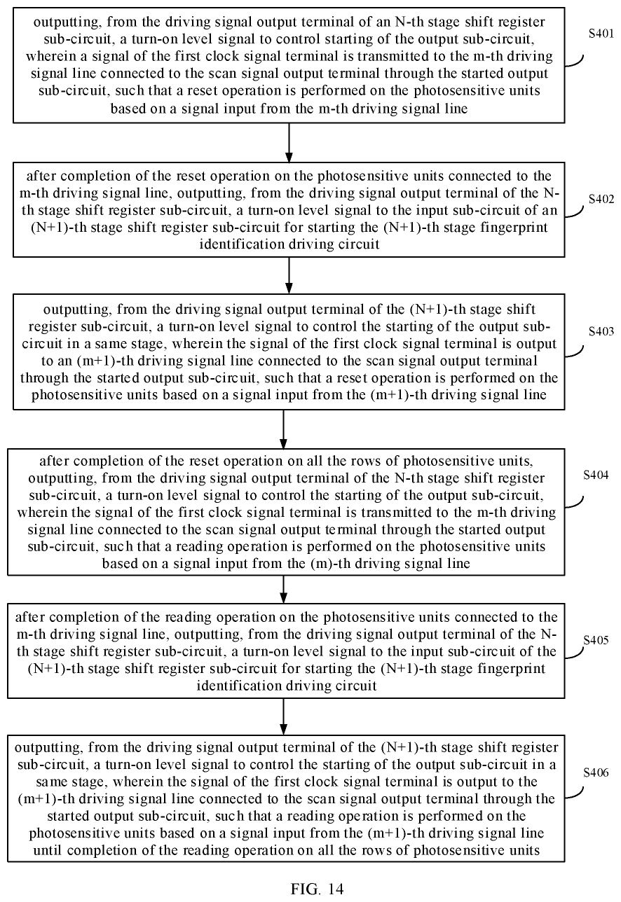

In a fourth aspect, FIG. 14 is a flowchart of a driving method for the fingerprint identification circuit shown in FIG. 10 according to an embodiment of the present disclosure. As shown in FIG. 14, the embodiment of the present disclosure provides a driving method for driving the fingerprint identification circuit, and the driving method may include the following steps S401 to S406.

At step S401, a turn-on level signal for controlling the starting of the output sub-circuit is output from the driving signal output terminal of the N-th stage shift register sub-circuit, and the signal of the first clock signal terminal is transmitted to the m-th driving signal line connected to the scan signal output terminal through the started output sub-circuit, so that the reset operation is performed on the photosensitive units based on the signal input from the m-th driving signal line.

At step S402, after the completion of the reset operation on the photosensitive units connected to the m-th driving signal line, a turn-on level signal is output from the driving signal output terminal of the N-th stage shift register sub-circuit (which may also me referred to as an N-th stage driving signal output terminal) to the input sub-circuit of the (N+1)-th stage shift register sub-circuit for starting the (N+1)-th stage fingerprint identification driving circuit.

At step S403, a turn-on level signal for controlling the starting of the output sub-circuit in the same stage is output from the driving signal output terminal of the (N+1)-th stage shift register sub-circuit, and the signal of the first clock signal terminal is transmitted to (or output to) the (m+1)-th driving signal line connected to the scan signal output terminal through the started output sub-circuit, so that the reset operation is performed on the photosensitive units based on the signal input from the (m+1)-th driving signal line.

At step S404, after the completion of the reset operation on all the rows of photosensitive units, a turn-on level signal is output from the driving signal output terminal of the N-th stage shift register sub-circuit to control the starting of the output sub-circuit, and the signal of the first clock signal terminal is transmitted to the m-th driving signal line connected to the scan signal output terminal through the started output sub-circuit, so that the reading operation is performed on the photosensitive units based on the signal input from the m-th driving signal line.

At step S405, after the completion of the reading operation on the photosensitive units connected to the m-th driving signal line, a turn-on level signal is output from the driving signal output terminal of the N-th stage shift register sub-circuit to the input sub-circuit of the (N+1)-th stage shift register sub-circuit for starting the (N+1)-th stage fingerprint identification driving circuit.

At step S406, a turn-on level signal is output from the driving signal output terminal of the (N+1)-th stage shift register sub-circuit to control the starting of the output sub-circuit in the same stage, and the signal of the first clock signal terminal is output to the (m+1)-th driving signal line connected to the scan signal output terminal through the started output sub-circuit, so that the reading operation is performed on the photosensitive units based on the signal input from the (m+1)-th driving signal line until the reading operation is completed on all the rows of photosensitive units.

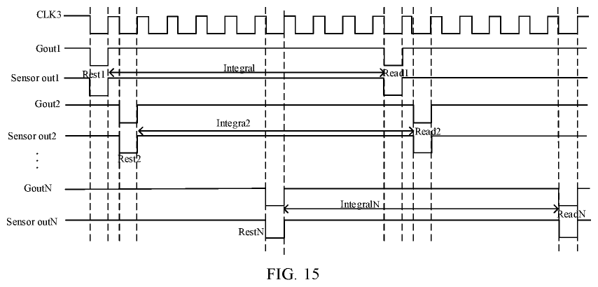

Illustratively, as shown in FIGS. 4, 10, 14 and 15, a turn-on level signal is output from the driving signal output terminal of the first stage shift register sub-circuit to control the starting of the output sub-circuit (i.e., to control the output sub-circuit to be started), and the signal of the first clock signal terminal is transmitted to the m-th driving signal line connected to the scan signal output terminal through the started output sub-circuit, so that the reading operation is performed on the photosensitive units based on the signal input from the (m)-th driving signal line.

After the completion of the reset operation on the photosensitive units connected to the first driving signal line, a turn-on level signal is output from the driving signal output terminal of the first stage shift register sub-circuit (which may also be referred to as the first stage driving signal output terminal) to the input sub-circuit of the second stage shift register sub-circuit to start the second stage fingerprint identification driving circuit. And then, a turn-on level signal is output from the driving signal output terminal of the second stage shift register sub-circuit to control the starting of the output sub-circuit in the same stage, and the signal of the first clock signal terminal is output to the second driving signal line connected to the scan signal output terminal through the started output sub-circuit, so that the reset operation is performed on the photosensitive units based on the signal input from the second driving signal line.

After the completion of the reset operation on all the rows of photosensitive units, a turn-on level signal is output from the driving signal output terminal of the first stage shift register sub-circuit to control the starting of the output sub-circuit, and the signal of the first clock signal terminal is transmitted to the first driving signal line connected to the scan signal output terminal through the started output sub-circuit, so that the reading operation is performed on the photosensitive units based on the signal input from the first driving signal line.

After the completion of the reset operation on the photosensitive units connected to the first driving signal line, a turn-on level signal is output from the first stage driving signal output terminal to the input sub-circuit of the second stage shift register sub-circuit to start the second stage fingerprint identification driving circuit. And then, a turn-on level signal is output from the driving signal output terminal of the second stage shift register sub-circuit to control the starting of the output sub-circuit in the same stage, and the signal of the first clock signal terminal is output to the second driving signal line connected to the scan signal output terminal through the started output sub-circuit, so that the reading operation is performed on the photosensitive units based on the signal input from the second driving signal line until the completion of the reading operation on all the rows of photosensitive units.

In the present embodiment, it is assumed that the time for completing the reset scanning of the N rows of sensors is TO, which is a value between the preset integration time durations T1 and TN of the system. In the fingerprint scanning process, after the integration time duration is determined based on the above integration time determination method as T, which is a certain value between the preset integration time durations T1 and TN of the system. If the determined integration time T is greater than or equal to the time TO for completing the reset scanning of the N rows of sensors, the following is performed sequentially for completing the fingerprint scanning of the N rows of sensors: the reset scanning of the sensors row-by-row, and then the reading scanning of the sensors row-by-row after a certain time duration has passed since the reset scanning.

In the present embodiment, since the signal output from the scan signal output terminal Sensor out is controlled by the signal output from the third clock signal terminal CLK3, the timing sequence of the fingerprint identification signal output from the third clock signal terminal CLK3 can be adjusted based on different application scenarios, that is, the integration time can be adjusted, so that each sensor is not saturated under strong light, and the speed of fingerprint identification is increased.

It will be understood that the above embodiments are merely exemplary embodiments employed to illustrate the principles of the present disclosure, and the present disclosure is not limited thereto. It will be apparent to one of ordinary skill in the art that various changes and modifications can be made therein without departing from the spirit and essence of the present disclosure, and these changes and modifications are to be considered within the scope of the present disclosure.

1. A fingerprint identification driving circuit, comprising a shift register sub-circuit and an output sub-circuit, wherein
the output sub-circuit is configured to transmit a signal input from a first clock signal terminal to a scan signal output terminal of the output sub-circuit for outputting, in response to a signal input from a driving signal output terminal of the shift register sub-circuit; and
the output sub-circuit is further configured to transmit a signal input from a first voltage signal terminal to the scan signal output terminal of the output sub-circuit for outputting, in response to a signal of a first node inside the shift register sub-circuit.

2. The fingerprinting identification driving circuit of claim 1, wherein the shift register sub-circuit comprises an input sub-circuit, a reset sub-circuit, and an output control sub-circuit;
the input sub-circuit is configured to transmit a signal input from an input signal terminal to a second node in response to a signal input from a second clock signal terminal;
the reset sub-circuit is configured to transmit a signal input from a second voltage signal terminal to the first node in response to the signal input from the second clock signal terminal;
the output control sub-circuit is configured to transmit a signal input from a third clock signal terminal to the driving signal output terminal in response to a signal of the second node, and is configured to transmit the signal input from the first voltage signal terminal to the driving signal output terminal in response to a signal of the first node;
the second node is a connection node between the input sub-circuit and the output control sub-circuit; and
the first node is a connection node between the reset sub-circuit and the output control sub-circuit.

3. The fingerprinting identification driving circuit of claim 2, wherein the input sub-circuit comprises: a first transistor having a first electrode connected to the input signal terminal, a second electrode connected to the second node, and a control electrode connected to the second clock signal terminal.

4. The fingerprint identification driving circuit of claim 2, wherein the reset sub-circuit comprises: a second transistor having a first electrode connected to the second voltage signal terminal, a second electrode connected to the first node, and a control electrode connected to the second clock signal terminal.

5. The fingerprint identification driving circuit of claim 2, wherein the output control sub-circuit comprises a third transistor, a fourth transistor, a first capacitor, and a second capacitor;
a first electrode of the third transistor is connected to the third clock signal terminal, a second electrode of the third transistor is connected to the driving signal output terminal, and a control electrode of the third transistor is connected to the second node;
one terminal of the first capacitor is electrically connected to the control electrode of the third transistor, and the other terminal of the first capacitor is connected to the second electrode of the third transistor;
a first electrode of the fourth transistor is connected to the driving signal output terminal, a second electrode of the fourth transistor is connected to the first voltage signal terminal, and a control electrode of the fourth transistor is connected to the first node; and
one terminal of the second capacitor is electrically connected to the control electrode of the fourth transistor, and the other terminal of the second capacitor is connected to the second electrode of the fourth transistor.

6. The fingerprinting identification driving circuit of claim 2, wherein the output sub-circuit comprises a fifth transistor and a sixth transistor;
a first electrode of the fifth transistor is connected to the first clock signal terminal, a second electrode of the fifth transistor is connected to the scan signal output terminal, and a control electrode of the fifth transistor is connected to the driving signal output terminal; and
a first electrode of the sixth transistor is connected to the first voltage signal terminal, a second electrode of the sixth transistor is connected to the scan signal output terminal, and a control electrode of the sixth transistor is connected to the first node.

7. The fingerprinting identification driving circuit of claim 1, further comprising a first control sub-circuit configured to transmit a signal of a second clock signal terminal to the first node in response to a signal of a second node.

8. The fingerprinting identification driving circuit of claim 7,
wherein the first control sub-circuit comprises: a seventh transistor having a first electrode connected to the first node, a second electrode connected to the second clock signal terminal, and a control electrode connected to the second node.

9. The fingerprinting identification driving circuit of claim 1, further comprising a second control sub-circuit configured to transmit a signal output from the first voltage signal terminal to a second node in response to a signal transmitted from a third clock signal terminal and a signal transmitted from the first node.

10. The fingerprinting identification driving circuit of claim 9, wherein the second control sub-circuit comprises an eighth transistor and a ninth transistor;
a first electrode of the eighth transistor is connected to a second electrode of the ninth transistor, and a second electrode of the eighth transistor is connected to the second node; a control electrode of the eighth transistor is connected to the third clock signal terminal; a first electrode of the ninth transistor is connected to the first voltage signal terminal, and a control electrode of the ninth transistor is connected to the first node.

11. A fingerprint identification circuit, comprising: a plurality of stages of fingerprint identification driving circuits each of which is the fingerprint identification driving circuit of claim 1, m driving signal lines and n reading signal lines crossing over the m driving signal lines, and photosensitive units arranged in an array of m×n, wherein
the photosensitive units in a same row are connected to a same driving signal line, and the photosensitive units in a same column are connected to a same reading signal line;
the driving signal output terminal of an N-th stage fingerprint identification driving circuit is connected to an input sub-circuit of an (N+1)-th stage fingerprint identification driving circuit; and
the scan signal output terminal of the N-th stage fingerprint identification driving circuit is connected to an m-th driving signal line, where N=m, and N, n and m are positive integers.

12. A driving method for driving a fingerprint recognition circuit, the fingerprint recognition circuit being the fingerprint recognition circuit of claim 11, the driving method comprising:
outputting, from the driving signal output terminal of an N-th stage shift register sub-circuit, a turn-on level signal to control starting of the output sub-circuit, wherein a signal of the first clock signal terminal is transmitted to the m-th driving signal line connected to the scan signal output terminal through the started output sub-circuit, such that a reset operation and a reading operation are performed on the photosensitive units based on a signal input from the m-th driving signal line; and
after completion of the reset operation and the reading operation on the photosensitive units connected to the m-th driving signal line, outputting, from the driving signal output terminal of the N-th stage shift register sub-circuit, a turn-on level signal to the input sub-circuit of an (N+1)-th stage shift register sub-circuit for starting the (N+1)-th stage fingerprint identification driving circuit; and then, outputting, from the driving signal output terminal of the (N+1)-th stage shift register sub-circuit, a turn-on level signal to control the starting of the output sub-circuit in a same stage, wherein the signal of the first clock signal terminal is output to an (m+1)-th driving signal line connected to the scan signal output terminal through the started output sub-circuit, such that a reset operation and a reading operation are performed on the photosensitive units based on a signal input from the (m+1)-th driving signal line.

13. A driving method for driving a fingerprint recognition circuit, the fingerprint recognition circuit being the fingerprint recognition circuit of claim 11, the driving method comprising:
outputting, from the driving signal output terminal of an N-th stage shift register sub-circuit, a turn-on level signal to control starting of the output sub-circuit, wherein a signal of the first clock signal terminal is transmitted to the m-th driving signal line connected to the scan signal output terminal through the started output sub-circuit, such that a reset operation is performed on the photosensitive units based on a signal input from the m-th driving signal line;
after completion of the reset operation on the photosensitive units connected to the m-th driving signal line, outputting, from the driving signal output terminal of the N-th stage shift register sub-circuit, a turn-on level signal to the input sub-circuit of an (N+1)-th stage shift register sub-circuit for starting the (N+1)-th stage fingerprint identification driving circuit; and then, outputting, from the driving signal output terminal of the (N+1)-th stage shift register sub-circuit, a turn-on level signal to control the starting of the output sub-circuit in a same stage, wherein the signal of the first clock signal terminal is output to an (m+1)-th driving signal line connected to the scan signal output terminal through the started output sub-circuit, such that a reset operation is performed on the photosensitive units based on a signal input from the (m+1)-th driving signal line;
after completion of the reset operation on all the rows of photosensitive units, outputting, from the driving signal output terminal of the N-th stage shift register sub-circuit, a turn-on level signal to control the starting of the output sub-circuit, wherein the signal of the first clock signal terminal is transmitted to the m-th driving signal line connected to the scan signal output terminal through the started output sub-circuit, such that a reading operation is performed on the photosensitive units based on a signal input from the (m)-th driving signal line; and
after completion of the reading operation on the photosensitive units connected to the m-th driving signal line, outputting, from the driving signal output terminal of the N-th stage shift register sub-circuit, a turn-on level signal to the input sub-circuit of the (N+1)-th stage shift register sub-circuit for starting the (N+1)-th stage fingerprint identification driving circuit; and then, outputting, from the driving signal output terminal of the (N+1)-th stage shift register sub-circuit, a turn-on level signal to control the starting of the output sub-circuit in a same stage, wherein the signal of the first clock signal terminal is output to the (m+1)-th driving signal line connected to the scan signal output terminal through the started output sub-circuit, such that a reading operation is performed on the photosensitive units based on a signal input from the (m+1)-th driving signal line until completion of the reading operation on all the rows of photosensitive units.
